(19) United States
(12) Patent Application Publication
(10) Pub. No.: US 2012/0169127 A1
(43) Pub. Date: Jul. 5, 2012

(54) POWER SUPPLY SYSTEM AND FUEL CELL BACKUP POWER SYSTEM THEREOF

(75) Inventors: Zhan-Yi LIN, Kwei Shan Township (TW); Jin-Ming Chang, Kwei Shan Township (TW); Chen-Kun Chou, Kwei Shan Township (TW); Yu-Ming Sun, Kwei Shan Township (TW); Chi-Bin Wu, Kwei Shan Township (TW)

(73) Assignee: Chung-Hsin Electric and Machinery Manufacturing Corp., Jhonghe City (TW)

(21) Appl. No.: 13/017,656

(22) Filed: Jan. 31, 2011

(30) Foreign Application Priority Data
Dec. 29, 2010 (TW) 099146472

(51) Int. Cl. H02J 9/00; H01M 8/06

(52) U.S. Cl. 307/66; 429/423

(57) ABSTRACT

A power supply system and a fuel cell backup power system thereof are provided. The power supply system includes: a mains power supply module for providing mains electricity to a load, and a fuel cell backup power system for providing electricity to the load while the mains electricity provided by the mains power supply module is insufficient. The fuel cell backup power system includes a fuel cell system, a power conditioning module, a battery, and a controller. The fuel cell system and the battery output first and second electrical energy, respectively. The controller defines a plurality of output power requirement levels for the fuel cell system, reads the power required by the load, and adjusts the output ratio between the first and the second electrical energy in a stepwise manner according to the output power requirement levels so as to meet the power required by the load.

### BACKGROUND OF THE INVENTION

1. Technical Field

The present invention relates to a power supply system and a fuel cell backup power system thereof. More particularly, the present invention relates to a power supply system and a fuel cell backup power system thereof, wherein a controller is configured to adjust the ratio between the electrical energy output respectively by a fuel cell system and a battery, so as to meet the power required by a load.

2. Description of Related Art

A fuel cell (FC) is a device for generating electricity by converting chemical energy directly into electrical energy. Featuring lower pollution, lower noise, higher energy density, and higher energy conversion efficiency than conventional electricity generating devices, fuel cells are a promising clean energy source applicable to a variety of fields such as portable electronic products, household and large-scale power generation systems, transportation means, military equipment, and the space industry, to name only a few.

The power generation process of a fuel cell involves the transport of reactants and products as well as the movement of electron flow; therefore, the output voltage of a fuel cell is affected to a great extent by the load device connected thereto. When the load device requires a large transient current, the reaction rate of the fuel cell must increase immediately in order to supply the required current to the load device. However, limited by the fuel delivery lines and the reaction product transport/removal mechanism in the fuel cell, it is practically impossible to provide the large current required by the load device within a short period of time. As a result, power failure tends to occur due to insufficient transient power supply.

To prevent such power failure, fuel cells are often used in conjunction with capacitors or secondary batteries so as to supply the required transient load current. Since capacitors have very limited energy density and are good only for supplying short pulse current, secondary batteries are the better complement to fuel cells when dealing with variable load devices.

A secondary battery refers to a battery that can be charged and discharged repeatedly, such as a lead-acid battery, a nickel-metal hydride battery, a nickel-cadmium battery, or a lithium battery. However, most secondary batteries have a working voltage range. A secondary battery charged above the upper voltage limit or discharged below the lower voltage limit is subject to serious damage and may even burn or explode.

In order to keep the voltage of a secondary battery used in conjunction with a fuel cell in between the upper and lower voltage limits, the most direct and effective way nowadays is to convert, by means of a DC/DC converter, the output voltage of the fuel cell to a voltage within the allowable voltage range of the secondary battery. While the DC/DC converter is capable of changing the output voltage of the fuel cell to within the working voltage range of the secondary battery, the energy conversion process results in power loss. In particular, the larger the difference between the output voltage of the fuel cell and the upper voltage limit of the secondary battery is, the more power will be lost during energy conversion. If a DC/DC converter of high conversion efficiency is used, the cost incurred will be considerable.

FIG. 1 schematically shows a conventional DC fuel cell backup power system. FIG. 2 is a plot showing the response time of a conventional fuel cell system in relation to load variation. FIG. 3 is a plot showing the response time of a conventional reformer in relation to load variation.

As shown in FIG. 1, a fuel cell backup power system 100 essentially includes a fuel cell system 110, a power conditioning module 120, a battery 130, a load 150, and a power supply 140. The power supply 140 is the main power source of the load 150 while the fuel cell system 110 and the battery 130 constitute an auxiliary backup power system (BPS). The main function of the fuel cell backup power system 100 is as follows. If, for one reason or another, the power supply 140 (e.g., mains electricity) fails to supply electricity to the load 150 continuously, the fuel cell backup power system 100 will supply electricity to the load 150 to prevent the work performed by the load 150 from being interrupted. The main backup power system in the aforesaid system is the fuel cell system 110.

However, unlike other backup power sources, the fuel cell system 110 requires a response time upon variation of the load 150. The response time is the time required for electrochemical reactions to take place in the fuel cell system 110. Only when the rated time is up can the fuel cell system 110 be loaded, or the service life of the fuel cell system 110 will be shortened.

Please refer to FIG. 2 for the load variation-response time curve of a fuel cell system. If it is required to significantly increase the power output from the fuel cell system 110, and the fuel cell stack in the fuel cell system 110 is forced to output the required power immediately, the fuel cell system 110 will suffer irreversible damage because of insufficient response time. Should it happen repeatedly, the fuel cell system 110 will end up permanently damaged. It should be noted that whether an increase in load is considered significant depends on system parameters and the properties of the fuel cell system 110.

In FIG. 2, for example, the increase in load is 25%. If the load 150 increases by more than 25% in a short time, the fuel cell stack in the fuel cell system 110 will need a response time of T₁ seconds, on condition that the hydrogen energy needed by the fuel cell stack is always available from the fuel cell system 110. Therefore, if the fuel cell system 110 uses a reformer to generate hydrogen, it is necessary to also take into account the response time of the reformer.

The load variation-response time curve of a reformer is shown in FIG. 3. Assuming the same 25% increase in load, the reformer requires a response time (T₂ seconds) longer than the response time of the fuel cell stack (i.e., T₂>T₁). If the load 150 to be supplied by the fuel cell backup power system 100 varies frequently by a large amount, the fuel cell stack and the reformer in the fuel cell system 110 will be loaded and unloaded repeatedly; in consequence, the service life of the reformer will be more or less affected even if sufficient response time is allowed.

### SUMMARY OF THE INVENTION

It is an object of the present invention to provide a power supply system and a fuel cell backup power system thereof. The power supply system uses the fuel cell backup power system as a backup power source, and the fuel cell backup power system includes a fuel cell system and a battery having a charge/discharge controller. The battery is timely charged and discharged to compensate for insufficiency of power supply from the fuel cell system.

It is another object of the present invention to provide a power supply system and a fuel cell backup power system thereof, wherein a controller defines a plurality of output power requirement levels for a fuel cell system, reads the power required by a load, and adjusts the output ratio between the fuel cell system and a battery in the fuel cell backup power system in a stepwise manner according to the output power requirement levels, with a view to extending the service life of the fuel cell system.

To achieve the above and other objects, the present invention provides a power supply system which includes a mains power supply module and a fuel cell backup power system. The mains power supply module is configured to provide mains electricity to a load. The fuel cell backup power system and the mains power supply module are connected in parallel by a selection switch and then connected in series to the load. Thus, the selection switch selectively allows the mains power supply module or the fuel cell backup power system to make electrical connection with the load. The fuel cell backup power system includes a fuel cell system, a power conditioning module, a battery, and a controller. The fuel cell system has a first output end for providing first electrical energy. The power conditioning module has a second input end and a second output end, wherein the second input end is electrically connected to the first output end. The battery includes a charge/discharge controller, is connected in parallel to the second output end, and serves to store or provide second electrical energy. The controller is configured to define a plurality of output power requirement levels for the fuel cell system, read the power required by the load, and adjust the output ratio between the first electrical energy and the second electrical energy in a stepwise manner according to the output power requirement levels so as to meet the power required by the load.

To achieve the above and other objects, the present invention also provides a fuel cell backup power system. The fuel cell backup power system and a mains power supply module are connected in parallel to a load by a selection switch. The fuel cell backup power system includes a fuel cell system, a power conditioning module, a battery, and a controller. The fuel cell system has a first output end for providing first electrical energy. The power conditioning module has a second input end and a second output end, wherein the second input end is electrically connected to the first output end. The battery includes a charge/discharge controller, is connected in parallel to the second output end, and serves to store or provide second electrical energy. The controller is configured to define a plurality of output power requirement levels for the fuel cell system, read the power required by the load, and adjust the output ratio between the first electrical energy and the second electrical energy in a stepwise manner according to the output power requirement levels so as to meet the power required by the load.

Implementation of the present invention at least involves the following inventive steps:

1. By adjusting the electrical energy output from the fuel cell system in a stepwise manner based on the output power requirement levels, the fuel cell stack and the reformer in the fuel cell system are prevented from being loaded and unloaded repeatedly, and the service life of the fuel cell system will be extended as a result.

2. As the fuel cell system works only at predefined output power levels, the reformer has a relatively simple operation mode and need not be loaded and unloaded repeatedly within a short period of time. Thus, the service life of the reformer will also be increased.

### BRIEF DESCRIPTION OF THE DRAWINGS

The features and advantages of the present invention are detailed hereinafter with reference to the preferred embodiments. The detailed description is intended to enable a person skilled in the art to gain insight into the technical contents disclosed herein and implement the present invention accordingly. A person skilled in the art can easily understand the objects and advantages of the present invention by referring to the disclosure of the specification, the claims, and the accompanying drawings, in which:

FIG. 1 a schematic drawing of a conventional DC fuel cell backup power system;

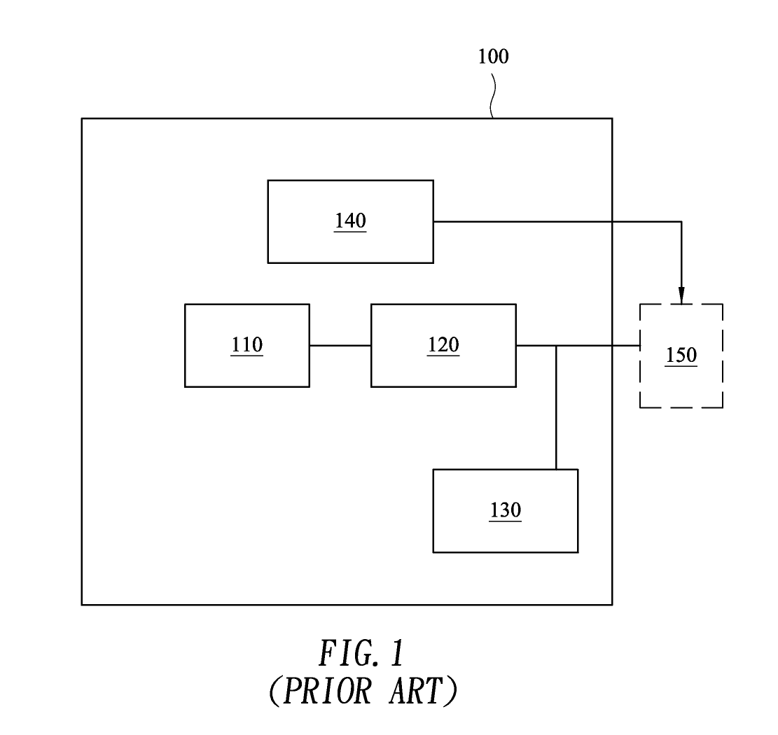

FIG. 2 is a plot showing the response time of a conventional fuel cell system in relation to load variation;

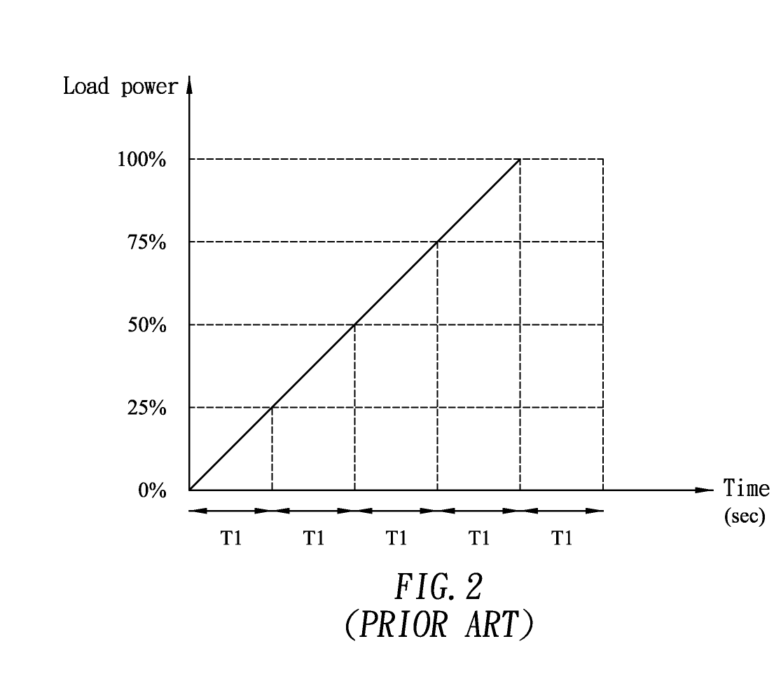

FIG. 3 is a plot showing the response time of a conventional reformer in relation to load variation;

FIG. 4 is a block diagram of a power supply system according to an embodiment of the present invention;

FIG. 5 is a block diagram of a power supply system according to another embodiment of the present invention;

FIG. 6 is a bar diagram showing the output ratio between the first and the second electrical energy of a fuel cell backup power system according to an embodiment of the present invention in relation to the power required by a load; and

FIG. 7 is a plot showing the relationship between the output power of the first electrical energy and the response time of a fuel cell system according to an embodiment of the present invention.

### DETAILED DESCRIPTION OF THE INVENTION

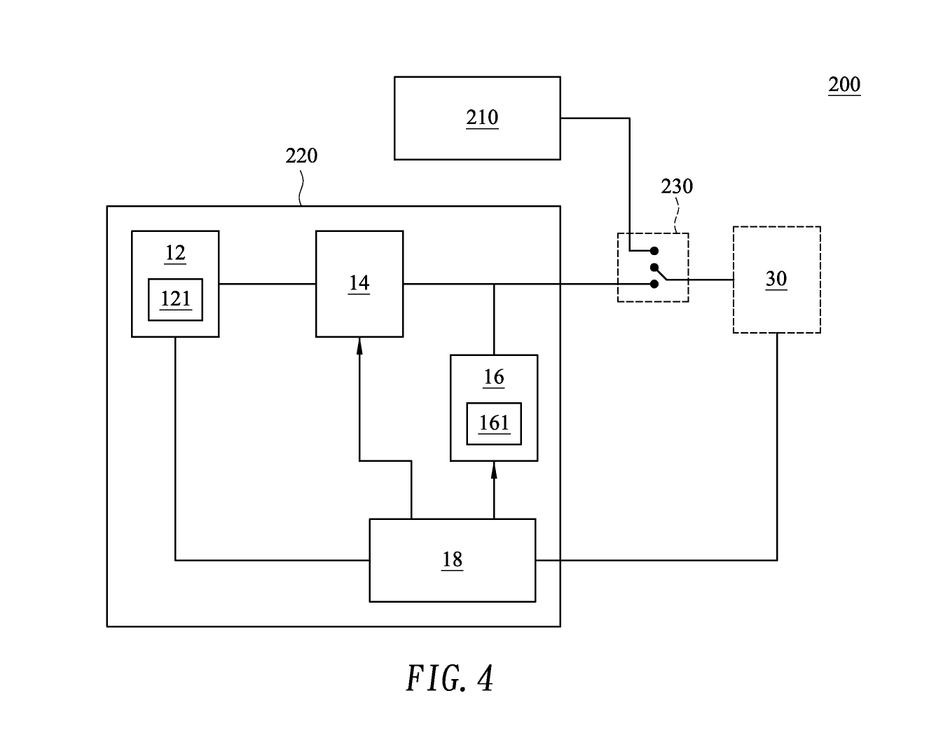

Referring to FIG. 4, a power supply system 200 according to an embodiment of the present invention includes a mains power supply module 210 and a fuel cell backup power system 220.

The mains power supply module 210 is configured to provide mains electricity to a load 30. The mains power supply module 210 and the fuel cell backup power system 220 are connected in parallel by a selection switch 230 and then connected in series to the load 30. Thus, the selection switch 230 selectively allows the mains power supply module 210 or the fuel cell backup power system 220 to be electrically connected to the load 30. In particular, when the mains power supply module 210 outputs no mains electricity, the selection switch 230 is switched to electrically connect the fuel cell backup power system 220 to the load 30.

The fuel cell backup power system 220 includes a fuel cell system 12, a power conditioning module 14, a battery 16, and a controller 18.

Referring to FIG. 4, the fuel cell system 12 has a first output end for providing first electrical energy. The fuel cell system 12 further includes a reformer 121. The fuel cell system 12 can be an alkaline fuel cell (AFC), a phosphoric acid fuel cell (PAFC), a molten carbonate fuel cell (MCFC), a solid oxide fuel cell (SOFC), a proton exchange membrane fuel cell (PEMFC), or a direct methanol fuel cell (DMFC).

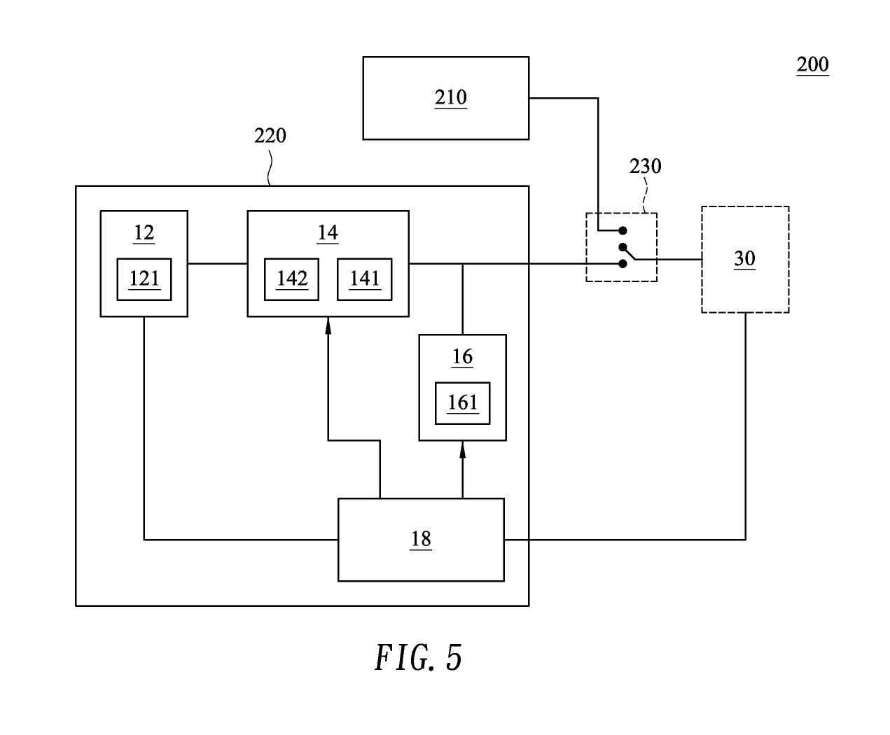

As shown in FIG. 4 and FIG. 5, the power conditioning module 14 has a second input end and a second output end, wherein the second input end is electrically connected to the first output end of the fuel cell system 12. The power conditioning module 14 may include a switching power supply 141 and a conditioner 142, wherein the conditioner 142 controls the switching power supply 141 in such a way that the switching power supply 141 receives the first electrical energy and converts it into a stable electrical energy for output.

With reference to FIG. 4, the battery 16 includes a charge/discharge controller 161. The battery 16 is connected in parallel to the second output end of the power conditioning module 14 and is configured to store/provide second electrical energy. The charge/discharge controller 161 serves to discharge the battery 16 or store the excess electricity generated by the fuel cell system 12 into the battery 16. The battery 16 can be a lead-acid battery, a nickel-metal hydride battery, a nickel-cadmium battery, a lithium battery, or other batteries having a charge/discharge mechanism.

As shown in FIG. 4, the controller 18 is configured to read the power required by the load 30 and define a plurality of output power requirement levels for the fuel cell system 12. Based on the output power requirement levels, the controller 18 performs a stepwise adjustment of the output power at which the fuel cell system 12 outputs the first electrical energy and the output power at which the battery 16 outputs the second electrical energy, for the purpose of meeting the power required by the load 30.

More specifically, the controller 18 defines n output power requirement levels for the fuel cell system 12, and m output power levels for the first electrical energy output by the fuel cell system 12. The m^{th} output power level of the first electrical energy is defined as m/n of the total output power of the fuel cell system 12, where n is a positive integer, and m is an integer larger than or equal to zero but not larger than n. In other words, the first electrical energy can only be output at m different levels; consequently, the reformer 121 of the fuel cell system 12 operates only at such fixed output power levels of the first electrical energy.

When the power required by the load 30, as read by the controller 18, lies between the m^{th} output power level and the m+1^{th} output power level of the first electrical energy, the controller 18 functions in such a way that the first electrical energy is output at the m^{th} output power level while the second electrical energy is output at an output power equal to the difference between the required power and the m^{th} output power level of the first electrical energy. That is to say, the difference between the required power and the m^{th} output power level is compensated by the second electrical energy output by the battery 16. When the required power equals the total output power of the fuel cell system 12, the controller 18 functions in such a way that the first electrical energy is output at the total output power of the fuel cell system 12 while the output power of the second electrical energy is zero.

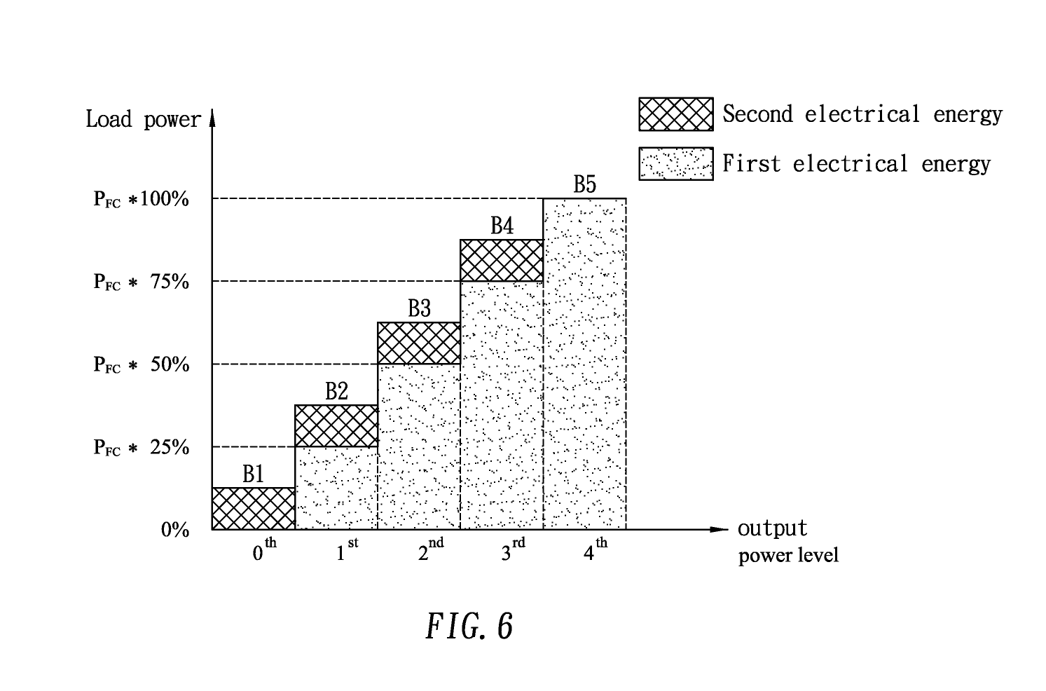

Reference is now made to FIG. 6 in conjunction with FIG. 4 and FIG. 5. The total output power (P_{fc}) of the fuel cell system 12 is divided into, for example, four output power requirement levels, namely P_{fc}*25%, P_{fc}*50%, P_{fc}*75%, and P_{fc}*100%. Given that the m^{th} output power level of the first electrical energy is defined as m/n of the total output power of the fuel cell system 12, the 0^{th} output power level of the first electrical energy is 0/4 of the total output power (i.e., P_{fc}*0%), the 1^{st} output power level of the first electrical energy is 1/4 of the total output power (i.e., P_{fc}*25%), the 2^{nd} output power level of the first electrical energy is 2/4 of the total output power (i.e., P_{fc}*50%), the 3^{rd} output power level of the first electrical energy is 3/4 of the total output power (i.e., P_{fc}*75%), and the 4^{th} output power level of the first electrical energy is 4/4 of the total output power (i.e., P_{fc}*100%).

When the load 30 is at an initial stage, and the power (B1) required by the load 30 is between 0% and 25% of the total output power of the fuel cell system 12, the second electrical energy of the battery 16 is enough for the work to be performed by the load 30. Hence, the controller 18 at this initial stage only causes the battery 16 to provide the second electrical energy to the load 30 and does not have to activate the fuel cell system 12. In other words, the first electrical energy is output at this stage at the 0^{th} output power level while the second electrical energy is output at an output power equal to the difference between the required power and the 0^{th} output power level (i.e., P_{fc}*0%).

When the power (B2) required by the load 30 is between the 1^{st} and the 2^{nd} output power levels, the controller 18 not only causes the fuel cell system 12 to output the first electrical energy constantly at the 1^{st} output power level (i.e., P_{fc}*25%), but also controls the battery 16 in such a way that the second electrical energy output therefrom fills in the gap between the required power and the 1^{st} output power level (i.e., P_{fc}*25%).

Similarly, when the power (B3) required by the load 30 is between the 2^{nd} and the 3^{rd} output power levels, the controller 18 not only causes the fuel cell system 12 to output the first electrical energy constantly at the 2^{nd} output power level (i.e., P_{fc}*50%), but also controls the battery 16 in such a way that the second electrical energy output therefrom compensates for the difference between the required power and the 2^{nd} output power level (i.e., P_{fc}*50%).

When the power (B4) required by the load 30 is between the 3^{rd} output power level (i.e., P_{fc}*75%) and the 4^{th} output power level (i.e., P_{fc}*100%), the controller 18 not only causes the fuel cell system 12 to output the first electrical energy constantly at the 3^{rd} output power level (i.e., P_{fc}*75%), but also controls the battery 16 in such a way that the second electrical energy output therefrom compensates for the difference between the required power and the 3^{rd} output power level (i.e., P_{fc}*75%).

Finally, when the power (B5) required by the load 30 equals the total output power of the fuel cell system 12, the controller 18 causes the fuel cell system 12 to output the first electrical energy at the 4^{th} output power level (i.e., P_{fc}*100%) so as to make full use of the total output power of the fuel cell system 12 and thereby meet the power required by the load 30. At the meantime, the controller 18 causes the second electrical energy of the battery 16 to be output at an output power equal to zero; in other words, the electricity of the battery 16 is not used at all.

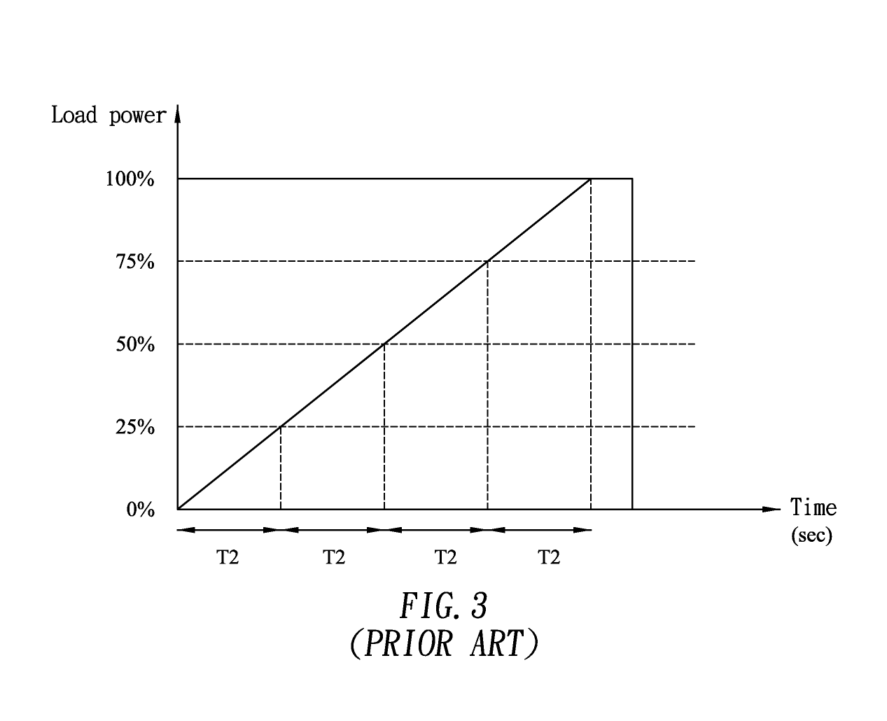

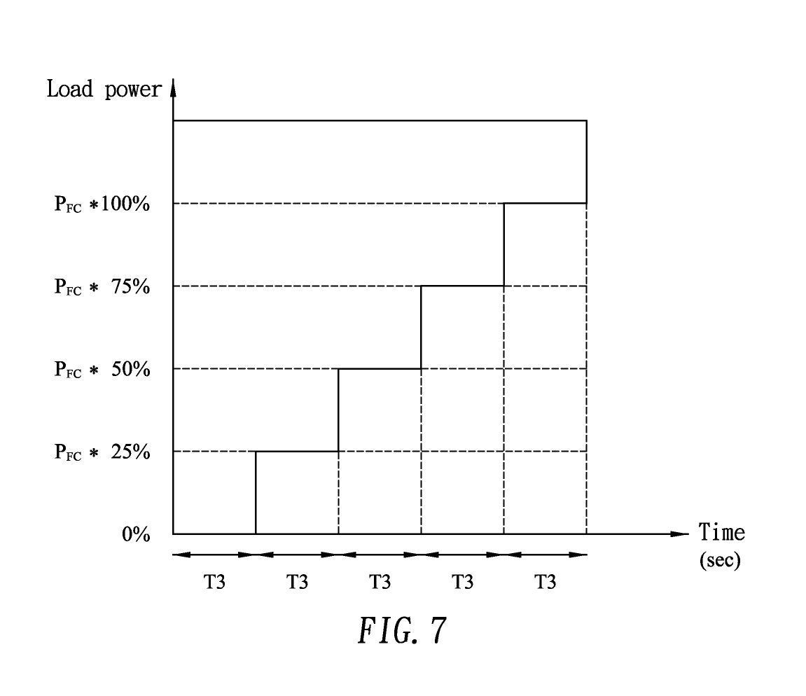

In contrast to the conventional operation mode which is characterized by the curve shown in FIG. 3, the reformer 121 in the disclosed embodiments of the present invention has a simpler operation mode as illustrated in FIG. 7 and is prevented from being loaded and unloaded repeatedly within a short period of time. Consequently, the reformer 121 in the fuel cell system 12 will have an extended service life. In FIG. 7, the response time T₃ of the fuel cell system 12 is the sum of the response times T₁ and T₂ of the fuel cell stack and the reformer 121 in the fuel cell system 12, as explained below. First of all, only when the response time T₂ of the reformer 121 is up will the amount of hydrogen required by the fuel cell stack be generated. And only when the required amount of hydrogen is generated will the response time of the fuel cell stack begin. That is why the total response time T₃ includes both T₁ and T₂. Furthermore, the reformer 121 operates only at preset levels. In the foregoing embodiment for example, the reformer 121 operates at four preset levels only. Nevertheless, the number of the operational levels of the reformer 121 may vary according to system requirements and is not limited by the present invention.

As a result, the fuel cell stack outputs electricity only at the predefined output power levels (e.g., P_{fc}*25%, P_{fc}*50%, P_{fc}*75%, and P_{fc}*100%). When the power required by the load 30 is between two consecutive output power levels, the difference between the required power and the lower of the two consecutive output power levels is supplied by the battery 16. However, as the electricity of the battery 16 decreases with time, there will eventually be insufficient electricity left to be supplied to the load 30. To deal with such a situation, the system is configured to detect the amount of electricity stored in the battery 16. Once the electricity of the battery 16 is below a certain level, the system instructs the controller 18 to regulate the fuel cell system 12 in such a way that the fuel cell system 12 outputs the electricity required by the load 30 so as to maintain stable power supply to the load 30. By controlling the power supply of the fuel cell system 12 in a stepwise manner, the fuel cell stack and the reformer 121 in the fuel cell system 12 are prevented from repeated loading and unloading; in consequence, the service lives of the fuel cell stack and the reformer 121 will both be extended.

The embodiments described above serve to demonstrate the features of the present invention so that a person skilled in the art can understand the contents disclosed herein and implement the present invention accordingly. The embodiments, however, are not intended to limit the scope of the present invention. Therefore, all equivalent changes or modifications which do not depart from the spirit of the present invention should fall within the scope of the appended claims.

What is claimed is:

1. A power supply system, comprising:
a mains power supply module for providing mains electricity to a load; and
a fuel cell backup power system connected in parallel to the mains power supply module by a selection switch and then connected in series to the load so that the selection switch selectively allows the mains power supply module or the fuel cell backup power system to make electrical connection with the load, wherein the fuel cell backup power system comprises:
a fuel cell system having a first output end for providing first electrical energy;
a power conditioning module having a second input end and a second output end, wherein the second input end is electrically connected to the first output end;
a battery comprising a charge/discharge controller, connected in parallel to the second output end, and configured to store or provide second electrical energy; and
a controller for defining a plurality of output power requirement levels for the fuel cell system, reading a power required by the load, and adjusting an output ratio between the first electrical energy and the second electrical energy in a stepwise manner according to the output power requirement levels so as to meet the power required by the load.

2. The power supply system of claim 1, wherein n said output power requirement levels are defined for the fuel cell system, and an m^{th} output power level of the first electrical energy is defined as m/n of a total output power of the fuel cell system, where n is a positive integer, and m is an integer not smaller than zero and not larger than n; wherein when the power required is between the m^{th} output power level and the m+1^{th} output power level of the first electrical energy, the controller causes the first electrical energy to be output at the m^{th} output power level and causes the second electrical energy to be output at an output power equal to a difference between the power required and the m^{th} output power level of the first electrical energy; and wherein when the power required equals the total output power of the fuel cell system, the controller causes the first electrical energy to be output at the total output power of the fuel cell system and causes the second electrical energy to be output at an output power equal to zero.

3. The power supply system of claim 1, wherein when the mains electricity is zero, the selection switch electrically connects the fuel cell backup power system and the load.

4. The power supply system of claim 1, wherein the power conditioning module comprises a switching power supply and a conditioner, the conditioner being configured to control the switching power supply in such a way that the switching power supply receives and converts the first electrical energy and outputs the converted first electrical energy.

5. The power supply system of claim 1, wherein the fuel cell system comprises a reformer.

6. A fuel cell backup power system, wherein the fuel cell backup power system and a mains power supply module are connected in parallel to a load by a selection switch, the fuel cell backup power system comprising:
a fuel cell system having a first output end for providing first electrical energy;
a power conditioning module having a second input end and a second output end, wherein the second input end is electrically connected to the first output end;
a battery comprising a charge/discharge controller, connected in parallel to the second output end, and configured to store or provide second electrical energy; and
a controller for defining a plurality of output power requirement levels for the fuel cell system, reading a power required by the load, and adjusting an output ratio between the first electrical energy and the second electrical energy in a stepwise manner according to the output power requirement levels so as to meet the power required by the load.

7. The fuel cell backup power system of claim 6, wherein n said output power requirement levels are defined for the fuel cell system, and an m^{th} output power level of the first electrical energy is defined as m/n of a total output power of the fuel cell system, where n is a positive integer, and m is an integer not smaller than 0 and not larger than n; wherein when the power required is between the m^{th} output power level and the m+1^{th} output power level of the first electrical energy, the controller causes the first electrical energy to be output at the m^{th} output power level and causes the second electrical energy to be output at an output power equal to a difference between the power required and the m^{th} output power level of the first electrical energy; and wherein when the power required equals the total output power of the fuel cell system, the controller causes the first electrical energy to be output at the total output power of the fuel cell system and causes the second electrical energy to be output at an output power equal to zero.

8. The fuel cell backup power system of claim 6, wherein the power conditioning module comprises a switching power supply and a conditioner, the conditioner being configured to control the switching power supply in such a way that the switching power supply receives and converts the first electrical energy and outputs the converted first electrical energy.

9. The fuel cell backup power system of claim 6, wherein the fuel cell system comprises a reformer.
